(19) United States
(12) Patent Application Publication
(10) Pub. No.: US 2007/0183463 A1
(43) Pub. Date: Aug. 9, 2007

(54) Method and arrangement for combining time-division multiplex signals

(76) Inventors: Laurent Cloutot, Zurich (CH); Gottfried Lehmann, Peterhausen (DE); Harald Rohde, Munchen (DE); Wolfgang Schairer, Unterschleissheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/590,239

(22) PCT Filed: Jul. 23, 2004
(86) PCT No.: PCT/EP04/08292

§ 371 Date: Aug. 22, 2006

(30) Foreign Application Priority Data
Feb. 25, 2004 (DE) 10 2004 009 138.2

(51) Int. Cl. H04J 3/02

(52) U.S. Cl. 370/537

(57) ABSTRACT

In one aspect a method for combining time-division multiplex signals in order to obtain a time-division multiplex signal, all of the signals having the same number on the periodic time-division multiplexed channels is provided. According to the method, a novel allocation of the content in non-occupied channels of the time-division multiplex signals is controlled in such a manner by a mutual time displacement of the content of occupied channels in the time-division multiplex signals, such that the combination thereof in the obtained time-division signal is collision free. In another aspect an arrangement which is suitable for carrying out the method, wherein any particular two time-division multiplex signals, for example, multiple bit rates of 10, 40, 80, 120, 160, etc. GBit/s are combined in a collision free manner.

The invention relates to a method and arrangement for combining time-division multiplex signals according to the generic portions of claims 1 and 16.

In the meshed optical time-division multiplex or OTDM networks of the future, time-division multiplex signals from different sources will be combined on one glass fiber and one wavelength. These time-division multiplex signals with time-division multiplexed channels originate from remote network elements or are aggregated at the site of a multiplexer. In the time-division multiplex signals to be combined often only a few of the available channels or time slots are occupied, e.g. because some OTDM channels have been “dropped” out of an incoming time-division multiplex signal. Generally where there are two incoming time-division multiplex signals for example, no more than the maximum number of channels available for a resulting time-division multiplex signal are occupied.

The object of the invention is to specify a method and arrangement, which allow the combination of time-division multiplex signals with optimized occupancy, in so far as some occupied and unoccupied channels with common time correspondence are contained in the time-division multiplex to be combined.

The object is achieved in respect of its method aspect by a method with the features of claim 1 and in respect of its device aspect by an arrangement with the features of claim 16.

In so far as the time-division multiplex signals are displaced in respect of each other temporally, e.g. by means of a delay element, such that a relative displacement results, in which every time slot is only occupied by a single channel of the time-division multiplex signals, both time-division multiplex signals can in principle be combined in a simple manner with an insertion facility.

If there is no such relative displacement, another method and a new arrangement, as described below, are required.

According to the invention a method is specified for combining at least two time-division multiplex signals to form a resulting time-division multiplex signal, all having the same number N of periodically time-division multiplexed channels, according to which the reciprocal time displacement of content from occupied channels in the time-division multiplex signals. allows a reassignment of the content into unoccupied channels of the time-division multiplex signals to be controlled such that they are combined into the resulting time-division multiplex signal in a collision-free manner. In other words, this method allows simple, channel-specific reassignment of channels in both time-division multiplex signals, such that before they are combined, all the channels of the two time-division multiplex signals with time correspondence are not occupied in a common manner with one content (e.g. transmitted data).

Basic conditions are to be taken into account for this method, in particular that with a number N1 of occupied channels of the first time-division multiplex signal and with a number N2 of occupied channels of the second time-division multiplex signal, the total number N1+N2 does not exceed the number N of channels of the resulting time-division multiplex signal. If this is not the case, i.e. the total number N1+N2 exceeds the number N, an advantageous solution is also defined, so that the combining of time-division multiplex signals with optimized occupation is ensured. As a basis for this solution, a further granularity, e.g. by means of wavelength conversion or switching of at least a subset of the channels of one of the two time-division multiplex signals to be combined is used, such that combining takes place in a collision-free manner with another time-division multiplex signal with a newly selected wavelength. Depending on the transmission technology used, further granularities—switching matrix, polarization, phase, etc.—can also be used. As far as the device is concerned, an additional add-drop module of an OTDM combining device can be connected upstream during wavelength switching for example, such that data channels at risk of collision in the OTDM combining device are output to a further OTDM combining device with a further assigned wavelength in this instance.

If three or more time-division multiplex signals with channel numbers N1, N2, N3 . . . are to be combined, this method is cascaded, i.e. two time-division multiplex respectively are combined first, which then in turn represent a new common time-division multiplex signal, which can then in turn be combined in the same manner with further time-division multiplex signals.

By reassigning data into channels with the least possible common use in a number of time-division multiplex signals transmitted in a common manner, this method thus allows effective compression of the bandwidth actually required during an OTDM transmission. This aspect is of the highest priority for a network provider, if said provider wishes to operate their available bandwidth in an optimum manner. The network user will also enjoy a higher data rate for the same bandwidth charge.

A further essential advantage of the invention for implementing the above method is that a simple and economical arrangement can be realized to combine at least two time-division multiplex signals to form a resulting time-division multiplex signal.

Assuming that all time-division multiplex signals have the same number N of periodic time-division multiplexed channels, a controller is connected to at least one time delay element provided for a time-division multiplex signal to be combined, for the reciprocal time displacement of content from occupied channels in the time-division multiplex signals. Also, for reassignment of this content into now unoccupied channels of the time-division multiplex signals, the controller is configured such that, with an optical coupler connected downstream from the time delay element, combining into the resulting time-division multiplex signal takes place in a collision-free manner.

Assuming that the incoming time-division multiplex signals respectively have a free channel and thus no reassignment is necessary during the combining of the time-division multiplex signals, at least one controlled reciprocal time displacement is still required.

Now with two time-division multiplex signals with some occupied and unoccupied channels with common time correspondence, to branch a content of an occupied channel with common time correspondence in one of the time-division multiplex signals, the time-division multiplex signal is fed into a drop module, the drop connection of which is connected to the time delay element for time displacement of the branched content of the channel. The controller is linked to the drop module and the time delay element via control signals to activate such branching and to set the time delay. Drop modules can be conventional add-drop modules. Remaining—i.e. unbranched—channels are routed through without delay, so the location of the dropped channel in the modified time-division multiplex signal remains completely free. The dropped channel signal is delayed and inserted again into the time-division multiplex signal routed through, such that the time-division multiplex signal thereby generated has one common occupancy less with the other time-division multiplex signal to be combined.

To identify the occupancy of channels with time correspondence between or during time-division multiplex signals, a detection unit is connected to the controller via a control signal. Some information about the detection unit is set out below. One alternative is to configure a network manager such that it outputs the above-mentioned control signal to the controller. Advantageous developments of the invention are specified in the subclaims.

One exemplary embodiment of the invention is described in more detail below with reference to the drawing, in which:

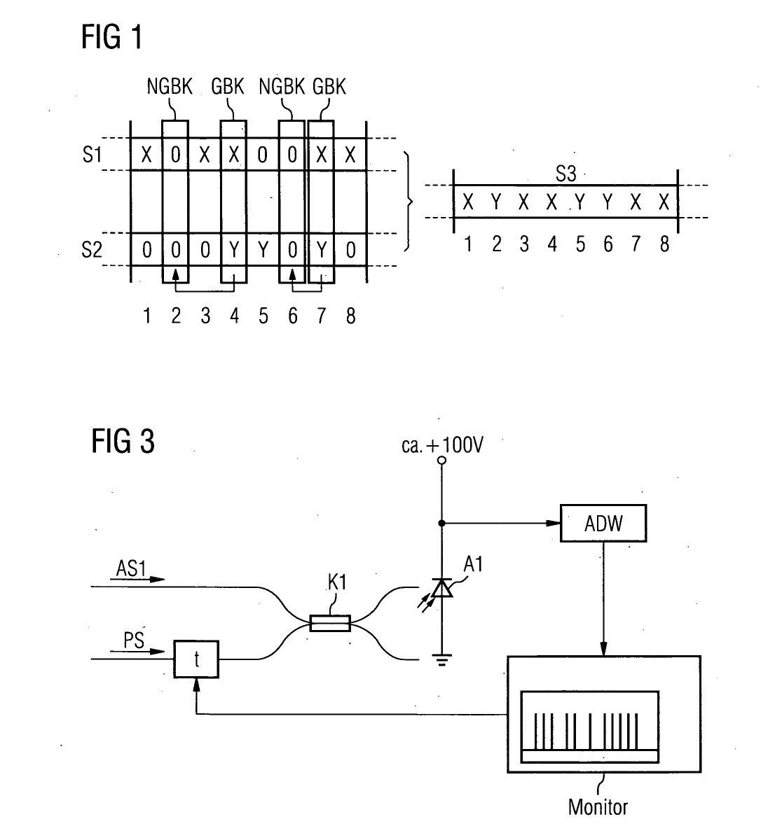

FIG. 1 shows a schematic diagram of the required reassignment of the content of the channels for the inventive combining of the time-division multiplex signals,

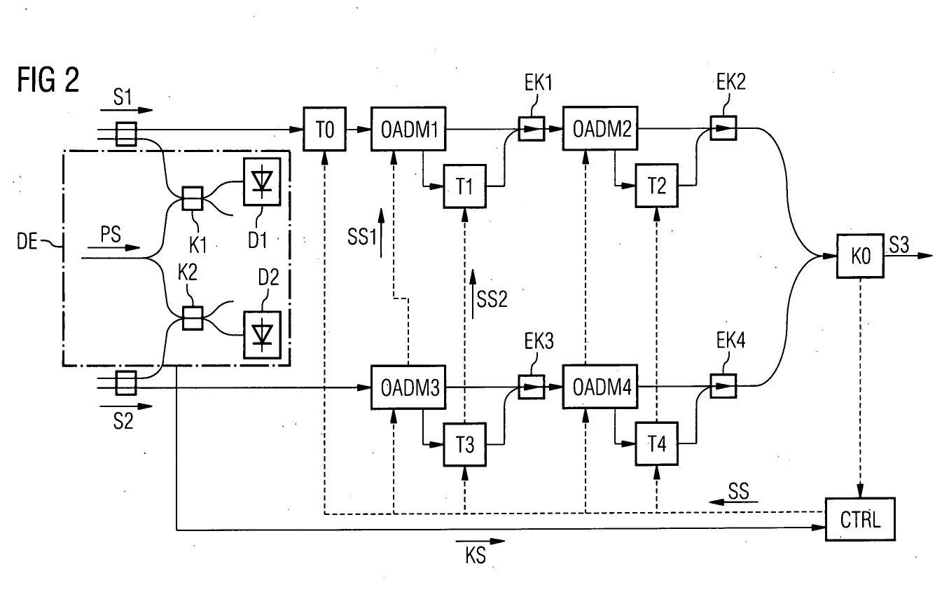

FIG. 2 shows an inventive arrangement for combining two time-division multiplex signals,

FIG. 3 shows a device for identifying the occupancy of channels with high bit-rate time-division multiplex signals,

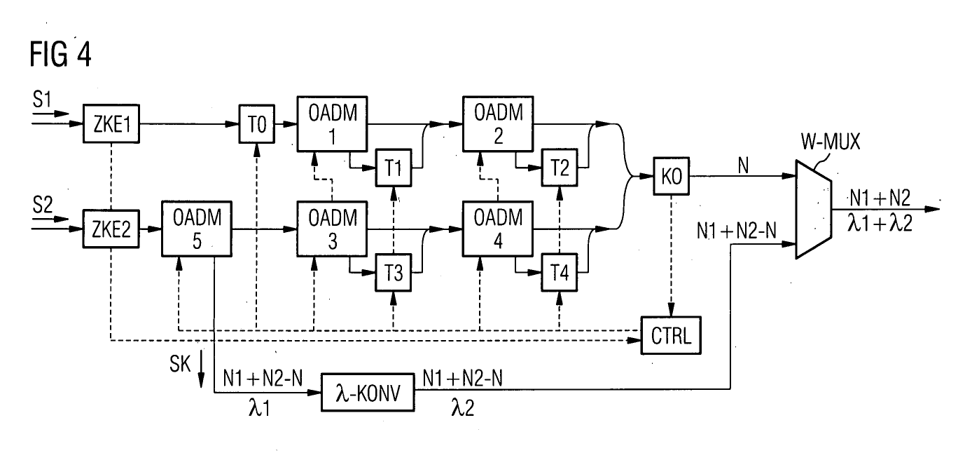

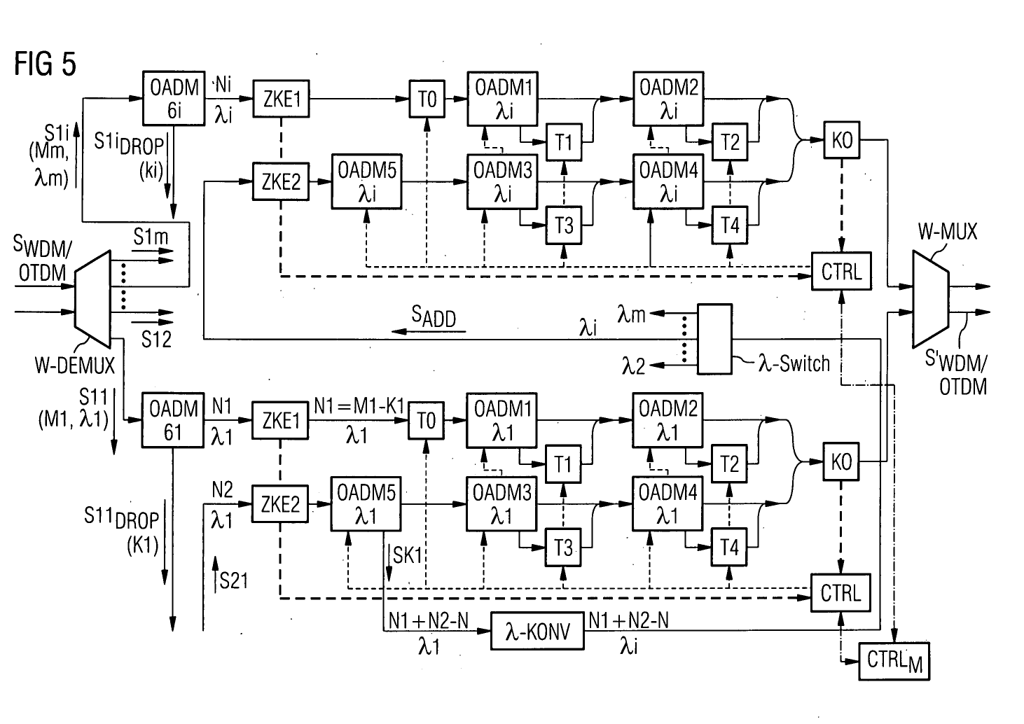

FIG. 4 shows a second arrangement for combining time-division multiplex signals in the event of a collision risk for their channels,

FIG. 5 shows a third arrangement for combining time-division multiplex signals in the event of a collision risk for their channels in an OTDM-WDM network node.

FIG. 1 shows a schematic diagram of a required reassignment of the content X, Y of the channels for the inventive combining of two time-division multiplex signals S1, S2 to form a resulting time-division multiplex signal S3 with periodically N=8 channels. The first and second time-division multiplex signals S1, S2 have the following sequence “XOXXOOXX” or “OOOYYOYO” within N=8 channels for occupied channels with content X, Y and for unoccupied channels with content O. The immediate combining of both time-division multiplex signals S1, S2 would cause a collision for commonly occupied channels with time correspondence GBK at the fourth and seventh positions (see above in bold) of both sequences. Channel-related combining can take place in a collision-free manner at other positions in the sequence. Both sequences now also have commonly unoccupied channels with time correspondence GNBK at the second and sixth positions (see above underlined) of both sequences, which are identified according to the method and then [lacuna] as free time slots or channels for the reassignment of the commonly occupied channels with time correspondence GBK still with collision potential. A possible solution to the reassignment in FIG. 1 is shown by means of two reciprocal time displacements of the content Y from the fourth and seventh time slots to the second or sixth time slot of the second time-division multiplex signal S2. There are then no more commonly occupied channels with time correspondence GBK and further channel combining can take place in a collision-free manner by simple addition.

FIG. 2 shows an inventive arrangement for combining two time-division multiplex signals according to the method from FIG. 1. The arrangement thus shown is suitable for a total of N=16 channels, i.e. for N1+N2=16 time-division multiplexed channels in each time-division multiplex signal S1 with N1 channels, S2 with N2 channels at both inputs of the arrangement. A signal element of both time-division multiplex signals S1, S2 is extracted here at the inputs and fed to a detection unit DE (see FIG. 3 for further details). The commonly occupied and unoccupied channels with time correspondence GBK, GNBK are thereby identified. Information about the occupancy or otherwise of these channels is output to a controller CTL via a control signal KS. The controller CTRL will implement the reassignment according to FIG. 1. The time-division multiplex signal S1 is fed to a drop module OADM1, with which a required channel or its content X is branched via one of its drop connections, only for the physical reassignment of detected commonly occupied channels with time correspondence GBK, e.g. in the time-division multiplex signal S1. The other unaffected—i.e. unbranched and not temporally delayed—channels or their content are simply let through by the drop module OADM1. The activation of such branching is effected from the controller CTRL via a control signal SS1 to the drop module OADM1. If it proves that the branched content X requires a time displacement of two time slots, so that combining can take place there in a collision-free manner, a delay element T1 is set correspondingly in respect of the drop connection. The criteria of this setting are notified from the controller CTRL by means of a further control signal SS2 to the delay element T1. An insertion facility EK1 is also connected downstream from the delay element T1, to allow reinsertion of the branched content of the now delayed signal into a corresponding free time slot of the time-division multiplex signal S1. It is also possible to set the time delay element T1 such that during reinsertion of the delayed signal at the drop connection the delay compared with the unaffected signal is one or more periods of a complete time-division multiplex signal plus the delay for insertion into a commonly unoccupied channel GNBK of this further time-division multiplex signal.

A further identical device chain, as described above for branching, time displacement and reinsertion, with a second drop module OADM2, a second delay element T2 and a second insertion facility EK2 is connected downstream from the insertion facility EK1. The same also applies to the second time-division multiplex signal S2, which is divided as for the first time-division multiplex signal S1 into two such device chains for branching, time displacement and reinsertion with further third and fourth drop modules OADM3, OADM4, delay elements T3, T4 and insertion facilities EK3, EK4. All the drop modules OADM1, OADM2, OADM3, OADM4 and all the time delay elements T1, T2, T3, T4 are controlled via control signals SS (see above SS1, SS2 for OADM1 and T1) at the output of the controller CTRL. An optical coupler KO is then connected downstream from the second and fourth insertion facilities T2, T4, which is only used for the optical combining of the now collision-free content of all the channels to form an outgoing time-division multiplex signal S3. An additional delay element TO can also be connected upstream from the first drop module OADMl and its delay can be set from the controller CTRL. If necessary, this allows a first inventive time displacement of all channels of the first time-division multiplex signal S1 to the second time-division multiplex signal S2, as well as fine synchronization between the time slots of the high bit-rate time-division multiplex signals S1, S2. Clock pulse and synchronization means are nevertheless provided to check and regulate any possible drifting of time slots at a number of points of the inventive arrangement but these were not shown in FIG. 2 for the sake of clarity. The drop modules used are conventional add-drop modules for branching a content from one of the commonly occupied channels with time correspondence GBK in the time-division multiplex signals S1, S2.

This exemplary embodiment is suitable for any collision scenarios that occur between occupied channels of the two time-division multiplex signals S1, S2, in so far as their total number does not exceed N=16.

The invention places no restriction on the selection of the bit rate of time-division multiplex signals or on the basic bit rate of their channels. At least three 10 GBit/s channels can arrive on the time-division multiplex signal S1 and seven 10 GBit/s channels on the time-division multiplex signal S2. To clarify the exemplary embodiment of the invention below however a bit rate of 40, 80, 120, 160, etc. GBit/s is considered for the time-division multiplex signals, having a multiple of 4 of the basic bit rate of 10 GBit/s of a channel.

In this instance the number N is a multiple of 4. To realize an appropriate arrangement for this purpose according to the model in FIG. 2 but for N time-division multiplexed channels, at least N/4 branches or reinsertions and N/4+1 time displacements are required for contents, X, Y of the channels of both time-division multiplex signals S1, S2. In other words, N/4 drop modules, N/4 insertion facilities and N/4+1 time delay elements are required. According to the example in FIG. 2 two drop modules, two insertion facilities and two (three with T1) time delay elements were arranged in series for the first time-division multiplex signal S1 and a further two drop modules, two insertion facilities and two time delay elements for the second time-division multiplex signal S2. This symmetrical arrangement for both time-division multiplex signals S1, S2 is advantageous compared with an asymmetrical arrangement such as three serial “drop modules, insertion devices and time delay elements” chains for the first time-division multiplex signal S1 and one serial “drop modules, insertion devices and time delay elements” chain for the second time-division multiplex signal S2, as in an asymmetrical arrangement the characteristics of the asymmetrically transmitted signals are influenced differently. In other words different amplification means for example have to be adjusted in each serial chain. Efforts are therefore made to ensure that the most identical number possible of channel-related branches, time displacements and reinsertions are used for each time-division multiplex signal S1, S2 to be combined.

In symmetrical arrangements a minimum whole number Int(N/8+0.5) of such “drop modules, insertion facilities and time displacement elements” chains is used for channel-related operations for one time-division multiplex signal S1, S2 in each instance.

FIG. 3 shows a device for identifying the occupancy of channels with high bit-rate time-division multiplex signals. Such a device according to FIG. 2 is what is referred to as a detection unit DE, which transmits information about the occupancy of channels to be merged with collision potential and about possible free time slots that are still available to prevent a collision to the controller CTL. The device shown here is described for a signal element AS1 of the time-division multiplex signal S1. The detection unit DE according to FIG. 2 has two such devices connected in parallel for each time-division multiplex signal S1, S2, the outputs of which are linked to the controller CTL.

The signal element with a data rate for example of 160 GBit/s is supplied with a further control pulse PS with the same bit rate and overlaid therewith at inputs of an optical coupler K1. An avalanche photodiode D1 is connected at one output of the optical coupler K1, the output signal of said avalanche photodiode D1 being fed to an analog/digital converter ADW. A monitor unit MONITOR is connected downstream from the analog/digital converter ADW and used to detect pulses in occupied or unoccupied channels. The avalanche photodiode D1 used here is sensitive to two-photon absorption. If the control pulse is now gradually subjected to a time delay and the photo-stream of the avalanche photodiode D1 is applied during the time delay, incursions occur in empty time slots. Instead of the avalanche photodiodes D1, as described above, any non-linear elements could be used such as a semiconductor amplifier or an optical fiber with a significant linear effect. Cascaded electro-acoustic modulators can also be used as detection units. As the bandwidth of the demultiplexer has to be at least half the bit rate of the time-division multiplex signal S1, S2, and if any empty time slots are to be detected (in the worst scenario, every second time slot), the use of a single electro-acoustic modulator, e.g. at 160 GBit/s, is not adequate.

If a signal element of the second time-division multiplex signal S2 is also output to a further identical device (see K2, D2 in FIG. 2), the same information is obtained in respect of the occupancy of its channels. By comparing output signals of respective analog/digital converters or monitor units, it is possible to determine the commonly occupied and unoccupied channels with time correspondence.

FIG. 4 shows a second arrangement for combining time-division multiplex signals S1, S2 according to FIG. 2 with a collision risk for their channels. The maximum number of channels is thereby N=16 and N1+N2>N can occur. A time slot controller ZKE1, ZKE2 is inserted respectively at inputs of the arrangement for both incoming signals S1, S2 to determine the position and number of the occupied time slots (data channels). An additional add-drop module OADM5 is connected downstream from the second time slot controller ZKE2, the switching output of said add-drop module OADM5 being connected to the input of the first add-drop module OADM3 in the path of the data signal S2. If the condition N1+N2<N is satisfied, the additional add-drop module OADM5 is set such that all the data channels according to FIG. 2 are supplied to combine the signals S1 and S2. If the scenario N1+N2>N occurs, a number of N1+N2-N data channels of the second time-division multiplex signal S2 are extracted in the additional add-drop module OADM5, such that the condition N1+N2=N is satisfied in the path with both add-drop modules OADM3, OADM4. The N1+N2−N extracted channels are fed—as a drop signal SK with a wavelength λ1—to a wavelength converter λ-KONV, which allocates a new wavelength λ2 to the corresponding data channels. This new wavelength λ2 must fit into the wavelength system selected for the network as a whole—optionally according to the standard ITU-T. Generally a number of N1 and N2 channels with wavelength λ1 are combined in a time-division multiplex signal S with N fully occupied channels at the output of the last-connected add-drop modules OADM2, OADM4 in both paths. The time-division multiplex signal S has wavelength λ1 and can also be combined by means of a wavelength multiplexer W-MUX with the previously extracted drop signal SK with the converted wavelength λ2 in a WDM transmission link. This results in an OTDM add device for time-division multiplex signals with any occupancy, with which at least one collision-free, fully occupied output time-division multiplex signal S is produced by means of a data valve—in this instance the add-drop module OADM5—with subsequent modification of the original granularity—in this instance the wavelength—of channels with a collision risk in both time-division multiplex signals S1, S2. Ideally the additional add-drop module OADM5 should make the channel selection such that the smallest possible sequence change or channel assignment has to be made by the next device according to FIG. 2. If the incoming signals should then be occupied as follows (0=unoccupied, x occupied for S1, y occupied for S2, N=8) [x0xx00xx] and [0y00yyy0], the solution with the least possible optical processing would be the following method: extracting the channel at the 6^{th} position of S2 at the additional add-drop module OADM5 and converting it to a different wavelength.

It should be noted here that future optical networks may have very complex structures and optimum use of network resources may only be achieved by means of a central network controller, which knows the statuses of all the network nodes with corresponding time-division multiplex devices. It may therefore be more favorable for the operation of the network as a whole or the sub-network to connect the additional add—drop module OADM5 between the time slot controller ZKE2 and the device described in FIG. 2—at the input signal S2—such that all incoming data channels of the time-division multiplex signal S2 are in the extraction light path leading to the wavelength converter λ-KONV.

A complete node architecture with one of the inventive devices must then of course be designed such that signals S_{WDM/OTDM} with a number of wavelengths have been multiplexed in previous nodes, each containing a data stream made up of OTDM signals. One exemplary embodiment of a node architecture, which takes this into account, is shown in FIG. 5, where such signals S_{WDM/OTDM} are separated in a wavelength demultiplexer W-DEMUX at the input of the node into a number of OTDM data streams S11, . . . , S1i, S1m with different wavelengths λ1, . . . , λi, . . . , λm and channels M1, . . . , Mi, . . . , Mm. It should also be taken into account here that data channels S11_{DROP}, . . . , S1i_{DROP}, . . . , S1m_{DROP} with a channel number L1, . . . , Ki, . . . , Km can also be branched at a node—in this instance by means of drop devices OADM61, . . . , OADM6i, . . . , OADM6m at outputs of the wavelength demultiplexer W-DEMUX, correspondingly creating new free time slots. Also the superfluous data channels, which can no longer be fed to the data streams with wavelengths λ1, . . . , λi, . . . , λm, are converted specifically to a wavelength that still has free capacity.

An arrangement ZKE1, ZKE2, OADM1, OADM2, OADM3, OADM4, OADM5, T0, T1, T2, T3, T4, KO, CTRL, λ-KONV according to FIG. 4 is now connected downstream at the switching output of the respective drop device OADM61, . . . , OADM6i, . . . , OADM6m with a first time-division multiplex signal S11, . . . , S1i, . . . , S1m with N1, . . . , Ni, . . . , Nm undropped data channels respectively, where Ni=Mi−Ki. A second time-division multiplex signal S21, . . . , S2i, . . . , S2m with N21, . . . , N2i, . . . , N2m (time-division multiplexed) data channels is combined with the first time-division multiplex signals S11, . . . , S1i, . . . , S1m via a time slot controller ZKE2 and an add-drop module OADM5 of each arrangement according to FIG. 4. If there is a collision risk between data channels of the first and second time-division multiplex signals S1i, S2i (i=1, . . . , m), the add-drop module OADM5 has [lacuna] from a drop signal Ski according to FIG. 4, to which another wavelength λj, where j≠I, is allocated via the wavelength converter λ-KONV and/or an additional wavelength switch λ-SWITCH. For reasons of clarity, this circuit is only shown for both time-division multiplex signals S11 and S21 according to FIG. 4. The wavelength-converted or switched signal S_{ADD} is also fed, as a second input time-division multiplex signal S2i, to a further arrangement according to FIG. 4, whose first time-division multiplex signal S1i to be combined has the same wavelength—λ1 in FIG. 4.

To control respective devices for combining at least two time-division multiplex signals S11, S12, . . . , S1i, S2i, . . . a controller CTL is present according to FIG. 2 or 4, connected in the simplest instance to a main controller CTRLM, such that in the event of a collision risk, a wavelength is converted or switched for data channels with a collision risk in one of the devices to a further device with a lesser collision risk—i.e. free time slots are available. At the end—coupler KO—of each device all the combined OTDM time-division multiplex channels having different wavelengths are in turn combined by means of a wavelength multiplexer W-MUX for further transmission of a WDM-OTDM signal S′_{WDM/OTDM}. Compared with the first incoming WDM-OTDM signal S_{WDM/OTDM}, the outgoing WDM-OTDM signal S′_{WDM/OTDM} has OTDM data streams with optimally fully occupied bandwidth per wavelength. This reduces the unnecessarily unoccupied data channels and increases bandwidth in the wavelength range. Time-division multiplex signals S1i_{DROP}, S2i with any data channels have also been removed from and/or inserted into the first incoming WDM/OTDM signal S_{WDM/OTDM}.

It should be emphasized that the precise architecture of a complete network node is also a function of the maximum number of wavelengths and OTDM data channels within a wavelength. For a small number of wavelengths, e.g. with 2 wavelengths, a 1 to 1 assignment can be expedient, i.e. both wavelengths can be converted to and inserted into the other wavelength respectively. With a number of wavelengths λ1, λ2, λ3, . . . a cascade may be expedient, to a conversion or switch between wavelengths λ1->λ2, λ2->λ3, etc. or the method, with which the OTDM channels weave into each other in a collision-free manner.

1.-29. (canceled)

30. A method for combining a plurality of incoming optical time-division multiplex signals to form a resulting time-division multiplex signal, the incoming signals and the resulting signal each have a maximum number of periodic time-division multiplexed channels, the method comprising:
identifying an occupancy of the channels for the incoming signals, the occupancy including a commonly occupied channel of the incoming signals and a commonly unoccupied channel of the incoming signals;
identifying a time correspondence of the identified occupancy; and
reassigning of a content of an occupied channel to an unoccupied channel via a reciprocal time displacement of the content,
whereby the content of the incoming signals are reordered and combined to form the resulting signal such that the combining is collision-free.

31. The method as claimed in claim 30, wherein by using the time correspondence of the occupied channel, the content of the occupied channel is branched from one of the incoming signals and temporally displaced until it corresponds temporally to the unoccupied channel.

32. The method as claimed in claim 30, wherein after the time displacement of a branched content, the branched content is inserted into one channel of the incoming signals and the incoming signals are optically coupled.

33. The method as claimed in claim 30,
wherein the plurality of incoming signals includes a first incoming signal and second incoming signal, and
wherein the sum of a count of occupied channels of the first incoming signal and a count of occupied channels of the second incoming signal does not exceed the maximum number channels of the resulting signal.

34. The method as claimed in claim 30,
further providing a total number of time-division multiplexed channels, the total number being a multiple of four, and
wherein a number of branches or a number of reinsertion is at least the total number divided by four and a number of time displacements is one more than quotient of the total number divided by four.

35. The method as claimed in claim 30, wherein if a total count of occupied channels of the incoming signals exceeds the number of channels of the resulting signal, the occupied channel of one of the signals is diverted and combined to form a further time-division multiplex signal.

36. The method as claimed in claim 35, wherein during diversion of the occupied channel a granularity characteristic is modified such that the diverted channel and the further signal are combined with the same granularity characteristics.

37. The method as claimed in claim 35, wherein wavelength is selected as the modified granularity.

38. The method as claimed in claim 35, wherein wavelength an identical number of branches, time displacements, reinsertions and optionally diversions is used for each incoming signal.

39. The method as claimed in claim 31, wherein for occupied and unoccupied channels the occupancy of channels of the incoming signals is identified before a channel is branched.

40. The method as claimed in claim 39, further comprises identifying a further occupancy of the channels before a further channel branching.

41. The method as claimed in claim 39, wherein the occupancy is identified from information from a network manager.

42. The method as claimed in claim 39, wherein the occupancy is identified from an extracted light element of one of the incoming signals being overlaid optically with a control pulse synchronized with the signal and the overlaid signal is output to an avalanche photodiode or a non-linear detection element that provides an output signal having information about the occupancy of a channel.

43. The method as claimed in claim 42, wherein a bit rate of the control pulse is tailored to a bit rate of the signals and the control pulse is gradually subjected to a time delay.

44. The method as claimed in claim 39, wherein occupancy is identified by demultiplexing the incoming signals having a bandwidth at least half the bandwidth of the signals.

45. The method as claimed in claim 31, wherein phases of the incoming signals are synchronized before the first branching of a content of their channels.

46. The method as claimed in claim 31, wherein a clock pulse of the branch and a time delay are regulated.

47. The method as claimed in claim 30, wherein during the combining of incoming signals a clock pulse synchronization is regulated.

48. An arrangement for combining a plurality of incoming optical time-division multiplex signals to form a resulting time-division multiplex signal, each signal having the same maximum number of periodic time-division multiplexed channels, the arrangement comprising:
a controller;
a detection unit identifying an occupancy of channels and channel time correspondence of the incoming signals, the detection unit operatively connected to the controller via a control signal, the occupancy including a commonly occupied channel of the incoming signals and a commonly unoccupied channel of the incoming signals;
a time delay element for the reciprocal time displacement of a content from the occupied channel in one of the incoming signals, the time delay element operatively connected to the controller; and
an optical coupler connected downstream from the time delay element to reassign the content to the unoccupied channel of the incoming signals,
wherein combining into the resulting signal occurs in a collision-free manner.

49. The arrangement as claimed in claim 48,
further comprises a drop module operative connected to the time delay element and to the controller, the controller activates the branching and sets a time delay,
wherein the incoming signals have a plurality of occupied and a plurality of unoccupied channels, and
wherein to branch a content of one of the occupied channels one of the plurality of incoming signals is fed into the drop module.

50. The arrangement as claimed in claim 48, further comprising a network manager connected to the controller via a control signal, wherein the network manager identifies the occupancy of channels with time correspondence between or during incoming signals.

51. The arrangement as claimed in claim 48, further comprising:
a drop module having an input and output;
and a further time delay element operatively connected to the output of the drop module,
wherein one of the signals is fed to an input of the drop module.

52. The arrangement as claimed in claim 51,
further comprises an insertion facility connected downstream from the further time delay element for reinsertion of a branched and time-delayed content of a channel into the original signal,
wherein the optical coupler is connected downstream from the insertion facilities.

53. The arrangement as claimed in claim 48, wherein the controller has a counter for the occupied and unoccupied channels.

54. The arrangement as claimed in claim 48, wherein the controller has a unit to assign the occupied channel to the unoccupied channels.

55. The arrangement as claimed in claim 49, wherein if there is a collision risk in respect of the content a drop module is connected upstream from the add-drop module.

56. The arrangement as claimed in claim 55, further comprises a wavelength converter or switch operatively connected to the output of the drop module such that a new wavelength is allocated to the channels of content with collision potential.

57. The arrangement as claimed in claim 56, wherein the channels with the new wavelength are an input signal fed into a further connected arrangement, the further arrangement combining a plurality of input signals to form a next resulting time-division multiplex signal, each signal having the same maximum number of periodic time-division multiplexed channels, the plurality of input signals includes the channels with the new wavelength, the further arrangement comprising:
a controller;
a detection unit identifying an occupancy of channels and channel time correspondence of the incoming signals, the detection unit operatively connected to the controller via a control signal, the occupancy including a commonly occupied channel of the incoming signals and a commonly unoccupied channel of the incoming signals;
a time delay element for the reciprocal time displacement of a content from the occupied channel in one of the incoming signals, the time delay element operatively connected to the controller;
an optical coupler connected downstream from the time delay element to reassign the content to the unoccupied channel of the incoming signals; and
a drop module operative connected to the time delay element and to the controller, the controller activates the branching and sets a time delay,
wherein the incoming signals have a plurality of occupied and a plurality of unoccupied channels,
wherein to branch a content of one of the occupied channels one of the plurality of incoming signals is fed into the drop module, and
wherein combining into the resulting signal occurs in a collision-free manner.
